(19) United States
(12) Patent Application Publication
(10) Pub. No.: US 2013/0147849 A1
(43) Pub. Date: Jun. 13, 2013

(54) DISPLAY APPARATUS FOR DISPLAYING SCREEN DIVIDED INTO A PLURALITY OF AREAS AND METHOD THEREOF

(71) Applicants: Ji-yeon KWAK, Seoul (KR); Kyung-a Kang, Seoul (KR); Hyun-jin Kim, Seoul (KR); Joon-kyu Seo, Seongnam-si (KR); Sang-keun Jung, Suwon-si (KR); Nipun Kumar, Suwon-si (KR); Jung-joo Sohn, Seoul (KR)

(72) Inventors: Ji-yeon KWAK, Seoul (KR); Kyung-a Kang, Seoul (KR); Hyun-jin Kim, Seoul (KR); Joon-kyu Seo, Seongnam-si (KR); Sang-keun Jung, Suwon-si (KR); Nipun Kumar, Suwon-si (KR); Jung-joo Sohn, Seoul (KR)

(73) Assignee: Samsung Electronics Co., Ltd., Suwon-si (KR)

(21) Appl. No.: 13/618,763

(22) Filed: Sep. 14, 2012

(30) Foreign Application Priority Data
Dec. 8, 2011 (KR) 10-2011-0131083

(51) Int. Cl. G09G 5/00

(52) U.S. Cl. 345/666

(57) ABSTRACT

A display device for enhancing user convenience includes a display unit which displays a screen divided into a plurality of areas displaying different types of objects thereon, and a control unit which changes sizes of the respective areas of the screen in relation to each other to avoid overlapping with each other, automatically reloads objects to be displayed on the changed areas from a source and reconstructs the screen, according to a user manipulation.

### PRIORITY

This application claims priority to Korean Patent Application No. 10-2011-0131083, filed in the Korean Intellectual Property Office on Dec. 8, 2011, the content of which is incorporated herein by reference.

### BACKGROUND OF THE INVENTION

1. Field of the Invention

The present invention relates generally to displaying a screen, and more particularly, to a device for displaying a screen divided into a plurality of areas and a method thereof.

2. Description of the Related Art

Recent advances in electronic technology have brought about increased development and distribution of various electronic apparatuses. In particular, portable electronic devices such as mobile phones, MPEG Layer Audio 3 (MP3) players, Personal Data Assistants (PDAs), and table Personal Computers (PCs) have been increasingly used.

Most recent electronic devices are equipped with display units that a user views to choose functions. A recent function is to download applications from application stores, or the like, and install the downloaded application on one's electronic device. An icon of the installed application is displayed on the background screen of the electronic apparatus.

Most of the current display devices provide the background screen on which icons representing applications or folders are listed. Accordingly, a user has to scroll a plurality of pages to find the application to execute from among numerous icons displayed thereon.

That is, since the currently available background screen provides limited function to search and execute the applications, there is a need in the art for an improvement of the current background screen, to satisfy user convenience. Accordingly, the need exists for a display device and a method thereof that are more intuitive and user-friendly.

### SUMMARY OF THE INVENTION

Embodiments of the present invention overcome the above disadvantages and other disadvantages not described above.

According to the present invention, provided is a display device and a method thereof, which provide a screen divided into a plurality of areas to provide increased user convenience.

According to the present invention, a display device includes a display unit which displays a screen divided into a plurality of areas displaying different types of objects thereon, and a control unit which changes sizes of the respective areas of the screen in relation to each other to avoid overlapping with each other, automatically reloads objects to be displayed on the changed areas from a source and reconstructs the screen, according to a user manipulation.

The control unit may reload objects displayed on an expanded area of the plurality of areas from the source, and rearrange the reloaded objects with existing objects according to a layout of the expanded area.

At least one of the plurality of areas may be scrollable in response to the user manipulation.

The control unit may expand or reduce at least one of the plurality of areas in accordance with the user manipulation, which touches on a boundary between the plurality of areas and drags, and adjust sizes of the remaining areas according to the degree of expansion or reduction.

In accordance with the user manipulation, which touches on one of the plurality of areas and drags to a direction of a boundary with another area, the control unit may expand the size of the touched area, while reducing the size of the remaining areas.

If two points in one area of the plurality of areas are touched and dragged apart from each other, the control unit may display detailed information on the area.

If the user manipulation is inputted, and touches on a plurality of points and moves the touched points apart from each other, the control unit may display an area hidden at a lower portion of the plurality of areas, on the screen.

The hidden area may display one of an application screen designated by the user, a most-recently executed application screen, and an application list.

In an embodiment, one of the plurality of areas may display an application list which displays a preferred function list and an entire application, objects displayed on the preferred function list and the application list may be movable therebetween depending on a choice of the user, and the application list may be scrollable.

The plurality of areas may include at least one of a text display area which displays text information, a content display area which displays media content, an icon display area which displays an icon representing a function provided by the display device, an application display area which displays an icon of the application, a message display area which displays a transmitted and received message, a preferred function display area which displays an icon representing a preferred function, and a widget area which provides a widget service.

The objects displayed on at least one of the plurality of areas may include a dynamic content playable on the screen.

In one embodiment, a display method is provided, which may include displaying a screen divided into a plurality of areas displaying different types of objects thereon, and changing sizes of the respective areas of the screen in relation to each other to avoid overlapping with each other, if a size of one of the plurality of areas is changed according to a user manipulation, and automatically reloading objects to be displayed on the at least one area of the changed areas from a source and reconstructing the screen.

The reconstructing the screen may include reloading objects displayed on an expanded area of the plurality of areas from the source, and rearranging the reloaded objects with existing objects according to a layout of the expanded area.

At least one of the plurality of areas may be scrollable in response to the user manipulation.

The sizes of the plurality of areas may be changed in accordance with the user manipulation, which touches on a boundary between the plurality of areas and drags, or which touches on one of the plurality of areas and drags to a direction of a boundary with another area.

If the user manipulation is inputted, and touches on a plurality of points and moves the touched points apart from each other, the display method may additionally include displaying an area hidden at a lower portion of the plurality of areas, on the screen.

The hidden area may display one of an application screen designated by the user, a most-recently executed application screen, and an application list.

If two points on one of the plurality of areas are touched and dragged apart from each other, the display method may additionally include displaying detailed information on the area.

The plurality of areas may include at least one of a text display area which displays text information, a content display area which displays media content, an icon display area which displays an icon representing a function provided by the display device, an application display area which displays an icon of the application, a message display area which displays a transmitted and received message, a preferred function display area which displays an icon representing a preferred function, and a widget area which provides widget service.

Alternatively, the objects displayed on at least one of the plurality of areas may include dynamic content playable on the screen.

In the present invention, the user is enabled to adjust a constitution of the screen as desired, while searching and enjoying the functions. As a result, convenience of use of the display device improves.

### BRIEF DESCRIPTION OF THE DRAWINGS

The above and/or other aspects of the present invention will be more apparent by describing embodiments of the present invention with reference to the accompanying drawings, in which:

FIG. 1 illustrates a display device according to an embodiment of the present invention;

FIG. 2 illustrates a method for varying constitution of the screen of the display device of FIG. 1;

FIGS. 3 and 4 illustrate an example of combining the respective areas on the screen according to the present invention;

FIG. 5 illustrates various examples of objects displayed on the respective areas on the screen;

FIG. 6 illustrates various methods for varying the size of the area;

FIG. 7 illustrates a process of displaying detailed information on one area according to user manipulation;

FIG. 8 illustrates information reloading performed according to area expansion;

FIG. 9 illustrates a process of varying displayed objects according to a scrolling in one area;

FIG. 10 illustrates a method for moving an icon;

FIG. 11 illustrates an example of user manipulation made to check a hidden area;

FIG. 12 illustrates a screen displaying thereon a hidden area in response to the manipulation of FIG. 11;

FIG. 13 illustrates a display device according to another embodiment of the present invention; and

FIG. 14 illustrates a display method of a display device according to an embodiment.

### DETAILED DESCRIPTION OF EMBODIMENTS OF THE INVENTION

Embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present invention. Accordingly, it is apparent that embodiments of the present invention can be performed without those specifically defined matters. Also, well-known functions or constructions are not described in detail for the sake of clarity and conciseness.

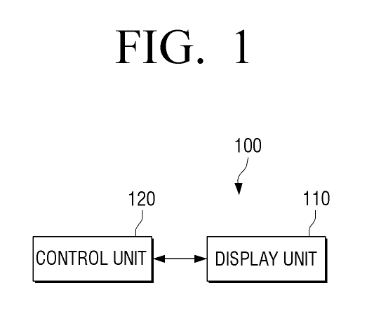

FIG. 1 illustrates a display device according to an embodiment of the present invention. Referring to FIG. 1, the display device 100 includes a display unit 110 and a control unit 120. The display device 100 of FIG. 1 is implemented in various devices with a display function, such as a mobile phone, PDA, tablet PC, laptop computer, PC, or Television (TV).

The display unit 110 displays a screen that is divided into a plurality of areas that display different types of objects. Herein, the term ‘object’ refers to an icon, photo, content, image, text, widget area, or the like which is displayable on the screen. The display unit 110 displays an initial background screen when the display device 100 is turned on and initialized. The background screen is divided into a plurality of areas that display different types of objects. Although a background screen will be explained herein, the following explanation may also apply to other types of screens.

The control unit 120 reconstructs the background screen according to user manipulation. Specifically, if the user expands or reduces one of the plurality of areas, the control unit 120 controls the display unit 110 and varies the sizes of the rest areas. The control unit 120 may then rearrange the objects displayed on the respective areas according to the varied sizes and layouts of the areas.

If the display unit 110 is implemented as a touch screen, the user manipulation may include touch-and-drag. That is, the user is able to expand or reduce the size of a corresponding area by directly touching on a specific area, or by touching on a boundary between areas and dragging the touched portion in a predetermined direction. If the size of one area is expanded, the sizes of the remaining areas are reduced to avoid overlapping. That is, the overall background screen is reconstructed.

The background screen is displayed when the display device 100 is turned on and initialization is completed. The user may select an icon on the background screen to execute various applications. When an application is executed, the background screen is replaced by an application execution screen. Meanwhile, the user may directly check the content of a media on the background screen, or directly check various pieces of information. That is, unlike the conventional background screen where icons are simply provided, the background screen of the display device 100 illustrated in FIG. 1 includes dynamic elements.

The control unit 120 enters into a power save mode by turning off the screen, if user input is not performed for a preset time while the background screen is displayed. If a key is selected or user touch is performed in the power save mode, the background screen is re-displayed. The number of areas and combinations of the areas displayed on the background screen is implemented in various manners.

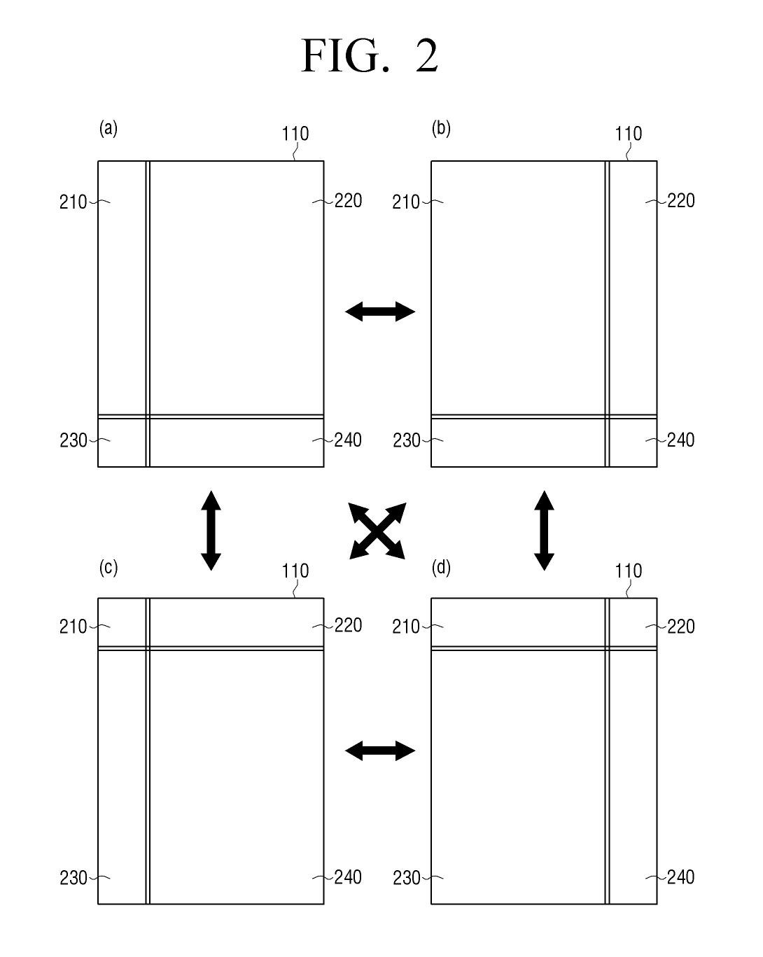

FIG. 2 illustrates a process of adjusting area size on the background screen. Referring to FIG. 2, the background screen is divided into first to fourth areas 210, 220, 230, 240. The sizes of the areas are variably displayed. Referring to (a) of FIG. 2, the second area is displayed in the largest size, while the remaining areas 210, 230, 240 are displayed in relatively smaller sizes. If the user touches boundary between the first and second areas 210, 220 and drags toward the right direction shown by the arrow between (a) and (b), the first area 210 increases in size on the background screen, with the second area 220 being reduced accordingly (b). Likewise, the third and fourth areas 230, 240 are expanded, respectively (c, d). As explained above, the user may reconstruct the background screen as desired.

On the respective areas of the background screen, objects are arranged in optimized forms under respective categories. The minimum basic information is provided before entering the application.

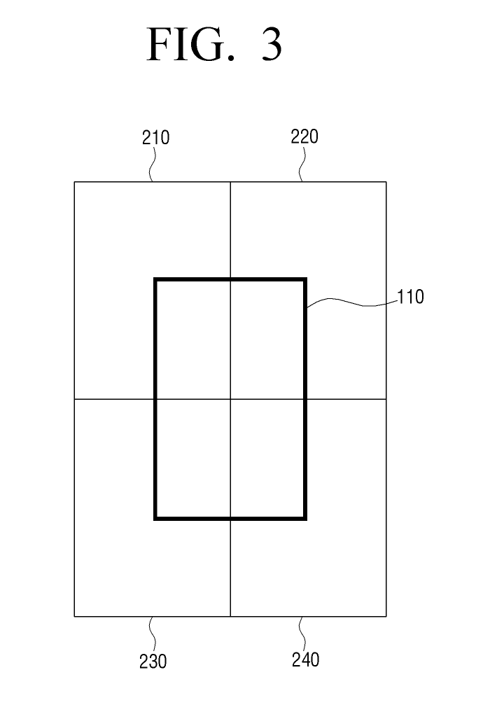

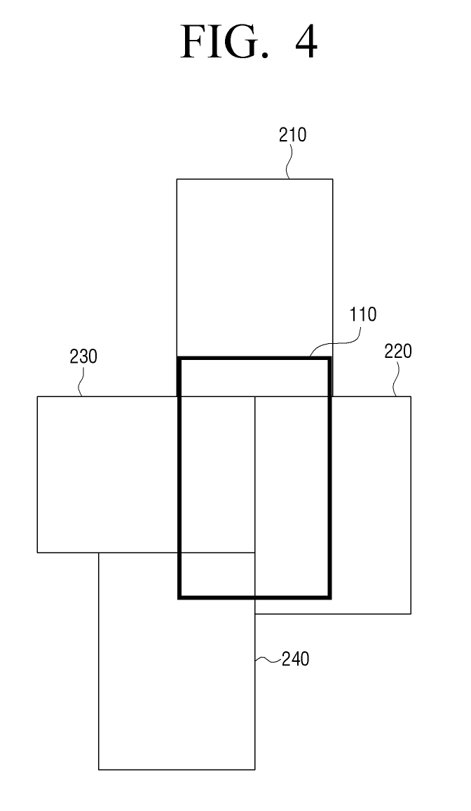

FIGS. 3 and 4 illustrate an example of combining the areas according to embodiments of the present invention.

Referring to FIG. 3, four areas 210 to 240 in the same size and same shape are arranged side by side in columns and rows, while the background screen in the similar size as that of the screen of the display device 100 is displayed on the display unit 110 of the display device 100 around the boundary between the areas 210 to 240.

Referring to FIG. 4, the areas 210 to 240 in different sizes and shapes from each other are arranged to cross each other, while a screen containing the boundary between the areas 210 to 240 is displayed on the display unit 110 as a background screen.

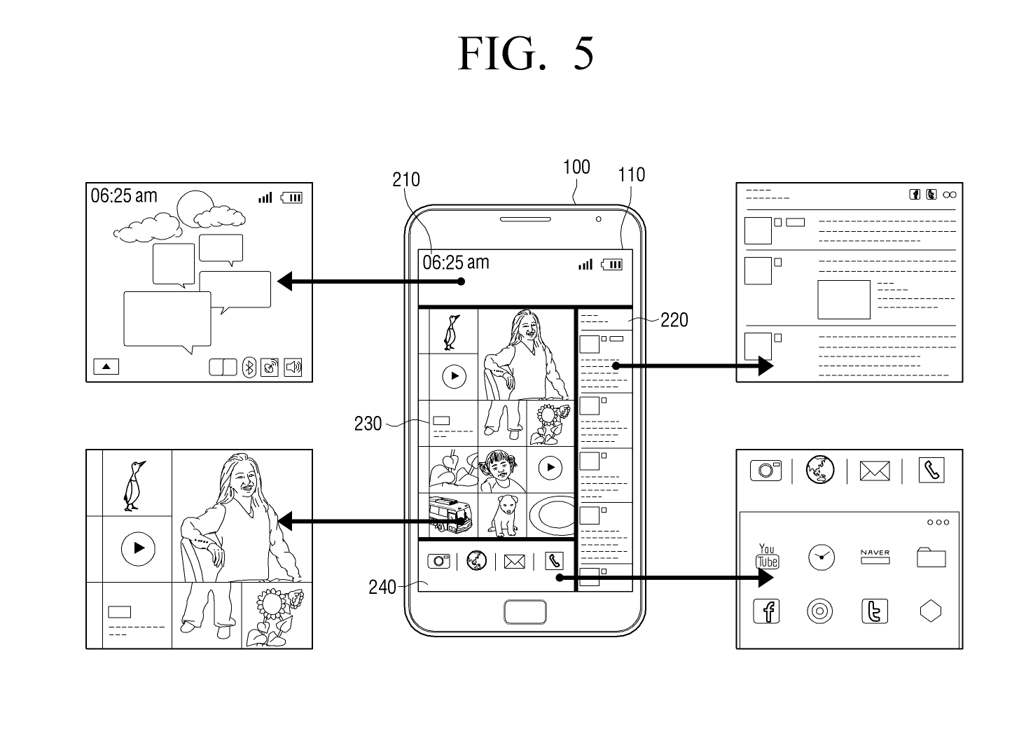

FIG. 5 illustrates an example of the respective areas of the background screen. Referring to FIG. 5, the first area 210 may display thereon information including recent update, device state, and notice information. The first area 210 may display thereon information regarding a result of executing various widget programs. Since the information is displayed in text form, the first area 210 is named ‘text display area’, or ‘contextual area’. The first area 210 may further include a widget display area for displaying widget information.

The second area 220 may display thereon various messages transmitted or received in accordance with the execution of Social Network Service (SNS) application or mail service. The messages displayed on the second area 220 are updated in real time basis and fed back. Further, if a new message is received, the previous messages are pushed behind by one step and displayed in a stepwise manner. The second area 220 is named ‘message display area’ or ‘SNS application area’.

The third area 230 may display thereon various types of media content, such as photo, video, or audio content. The media content is recently updated and directly controlled on the third area 230. That is, the user may play back and view the content displayed on the third area 230, or may stop, fast forward or rewind the content. The media content is displayed in a thumbnail image, and content such as video or audio is added with a Graphic User Interface (GUI) icon ( [symbol] ) to indicate that the content can be played back. Referring to FIG. 5, the media contents are not always displayed in the same size and forms. That is, some contents are displayed in larger sizes. The third area 230 is named ‘content display area’.

The fourth area 240 displays a preferred function on which icons representing preferred function are displayed. The preferred function is set by the manufacturer of the display device 100 by default, or may be selected by the user or automatically registered on the preferred function display area according to the frequency of use thereof, without requiring separate selection. When the fourth area 240 is scrolled according to the user's selection, the fourth area 240 may display icons representing functions provided by the display device or icons of the applications. That is, the fourth area 240 may include the icon display area, the application display area, and the preferred function display area altogether.

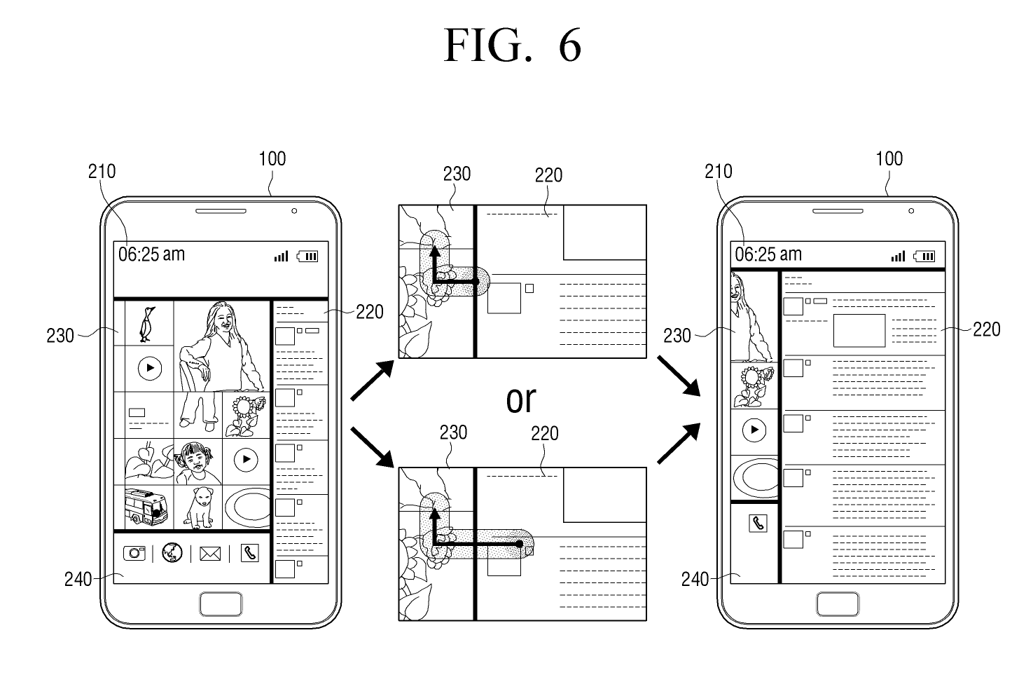

FIG. 6 illustrates various methods for reconstructing a background screen. Referring to FIG. 6, the user may adjust the sizes of the areas as desired, on the background screen that is divided into a plurality of areas 210 to 240.

That is, if the user touches on the boundary between the second and third areas 220, 230, drags to the direction of the third area 230, and then drags to the direction of the first area 210, or directly touches on the second area 220 and drags the same to the upper left direction, the second area 220 is expanded to the upper left direction, while the remaining areas 210, 230, 240 are relatively reduced in size.

In the second area 220, the objects are rearranged according to the size expanded to the maximum. Referring to FIG. 6, before the expansion, the second area 220 displays photo and information about a main agent of message transmission and reception, while displaying part of the transmitted and received messages beneath the second area 220. After the expansion is applied, the photo and information about the main agent of the message transmission and reception are arranged in a line on the left side portion within the second area 220, and the entire message and attached image to the message are displayed on the side thereof.

If the second area 220 increases to the maximum size, then minimum base objects are displayed on the remaining areas 210, 230, 240. For example, the first area 210 may display information such as current time, remaining battery life, and sensitivity of frequency reception, the fourth area 240 may display icons regarding telephone function, and the third area 230 may display small sizes of media content images.

When the area expansion is applied, the user may wish to select a corresponding area to check the details.

FIG. 6 illustrates an example in which the background screen is reconstructed according to both the manipulation that uses the boundary area, and manipulation that touches on the area. However, other examples are also possible. Accordingly, the background screen may be reconstructed in response to only one of the above-mentioned manipulations.

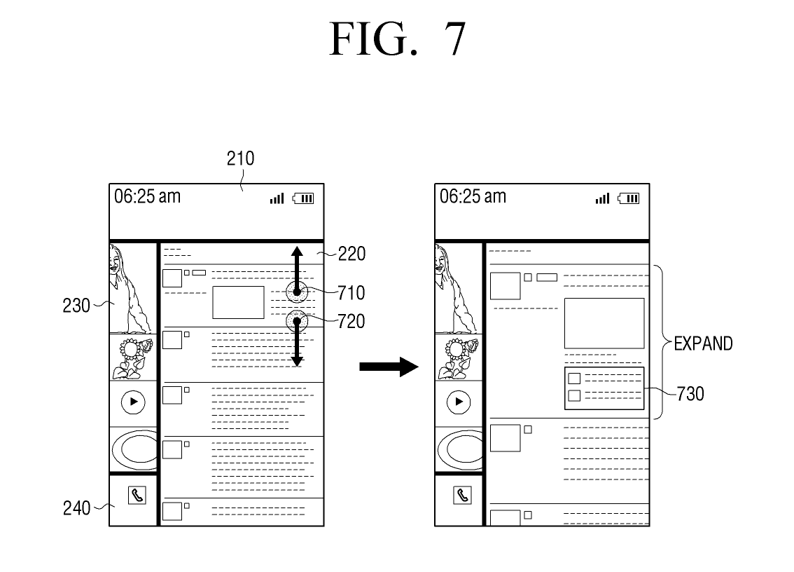

FIG. 7 illustrates a process of a user checking the details by selecting some message when the second area 220 is expanded in the manner illustrated in FIG. 6. That is, the user may touch on the two points 710, 720 of the information that the user wishes to check with two fingers, and drag the points apart from each other. According to the manipulation, detailed information 730 of the touched information is displayed. Ripples are additionally displayed to the corresponding message. FIG. 7 illustrates the second area 220 for the sake of explanation. However, the detailed information may also be displayed on the remaining areas in response to the manipulation explained above.

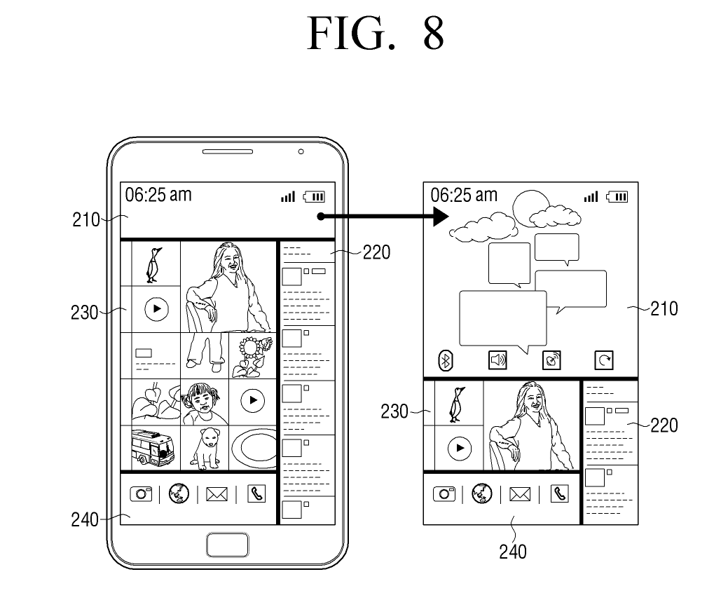

FIG. 8 illustrates a method for reconstructing an object, when the first area 210 from among the plurality of areas is expanded. Referring to FIG. 8, the first area 210 displays only the minimum information before the expansion, and upon implementation of the expansion, displays various text or image information such as device status information and update message and widget information, in accordance with execution of various widgets. The information is automatically reloaded in response to the expansion operation. That is, upon initiation of the expansion, the display device 100 reads out the stored information, or rechecks the device status to update the objects to be displayed on the first area 210. Alternatively, the display device 100 may access an external source, i.e., to the server, to receive new information and update the objects accordingly. Specifically, the display device 100 may access the server using the IP of the server that provides the objects to be displayed on the expanded area. The display device 100 may then request update information about the objects to be displayed and receive the requested information. Accordingly, the reloaded objects are appropriately rearranged in the corresponding area along with the existing objects within the area. The object reloading is performed in all of the plurality of areas or only in the expanded area.

Although FIG. 8 illustrates the first area as an example, the reloading of the objects corresponding to the other areas may also be performed when the corresponding areas are expanded.

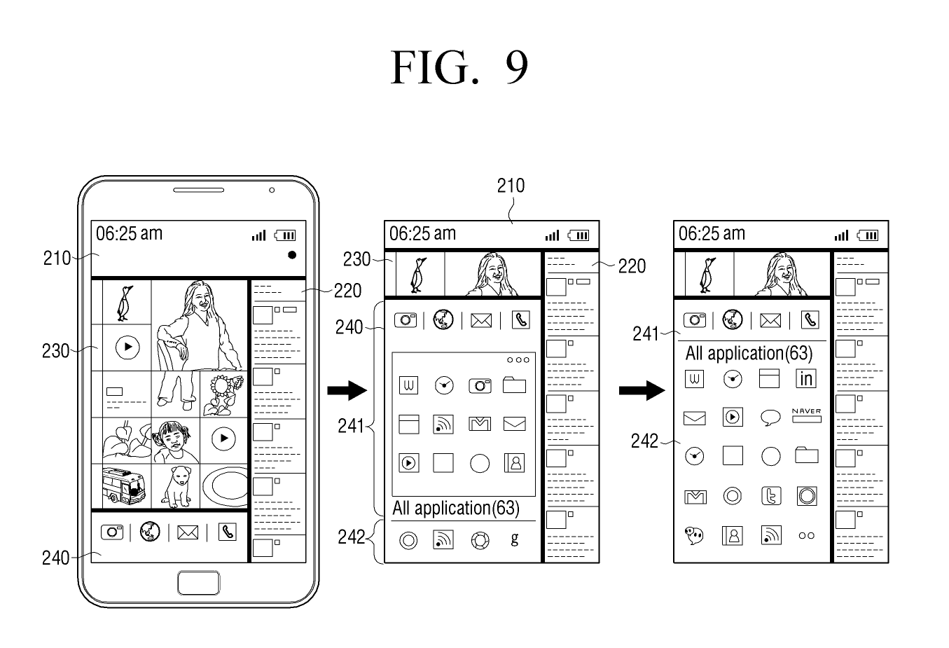

FIG. 9 illustrates an example in which the user checks information while scrolling one of the plurality of areas. In FIG. 9, the fourth area 240 is expanded. Before the expansion, the fourth area 240 displays only the preferred function icon, but after the expansion, the fourth area 240 may display a preferred function list 241, and an application list 243 for displaying icons representing all of the applications.

The functions displayed on the preferred function list 241 are arranged in folder manner. That is, if the folder displayed on the preferred function list 241 is selected, lists of lower preferred functions corresponding to the selected folder are opened.

This area may display many icons or objects in response to scroll manipulation of the user. That is, if the user touches on a list and slaps quickly in a particular direction, the scrolling is performed in the direction of the slap. Accordingly, objects or icons displayed on a corresponding list may vary.

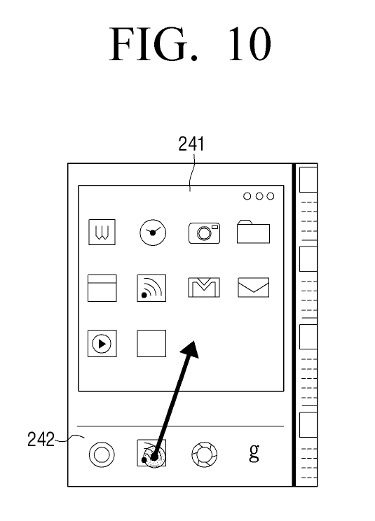

FIG. 10 illustrates a manner of moving the displayed objects among the lists. Referring to FIG. 10, if the user touches on one icon on the application list 242, drags to the direction of the preferred function list 241, and then releases the touching, a corresponding icon is moved to and displayed on the preferred function list 241. As explained above, the user may change the location of the object or icons among the lists or in the same list.

While the example of the background screen consisting of four areas has been explained above, the invention is not limited thereto. That is, depending on embodiments, two or three or five or more areas may construct one background screen. The number of areas and pattern of combining the areas are variably determined depending on such variables as the size of the screen and type of the objects.

Meanwhile, a hidden area is provided in addition to the plurality of areas displayed on the background screen to entertain the user when manipulating the display device 100. That is, the hidden area, hidden in a lower portion in Z-axis direction, is displayed on the background screen as the user unfolds the respective divided areas on the background screen.

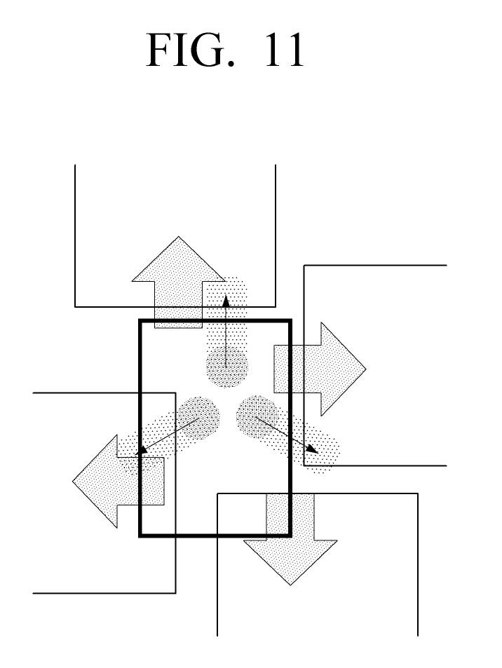

FIG. 11 illustrates a user manipulation that is made to check the hidden area. Referring to FIG. 11, the hidden area appears when the user touches on random three points on the background screen with three fingers and motions to apart the points from each other. The user does not always have to touch on the three points. Accordingly, the hidden area may appear when two or four or more points are touched and motioned to be apart from each other. For example, if a user manipulation as inputted separates two different areas of the plurality of areas apart from each other, the touched areas are moved apart from each other, showing the hidden area.

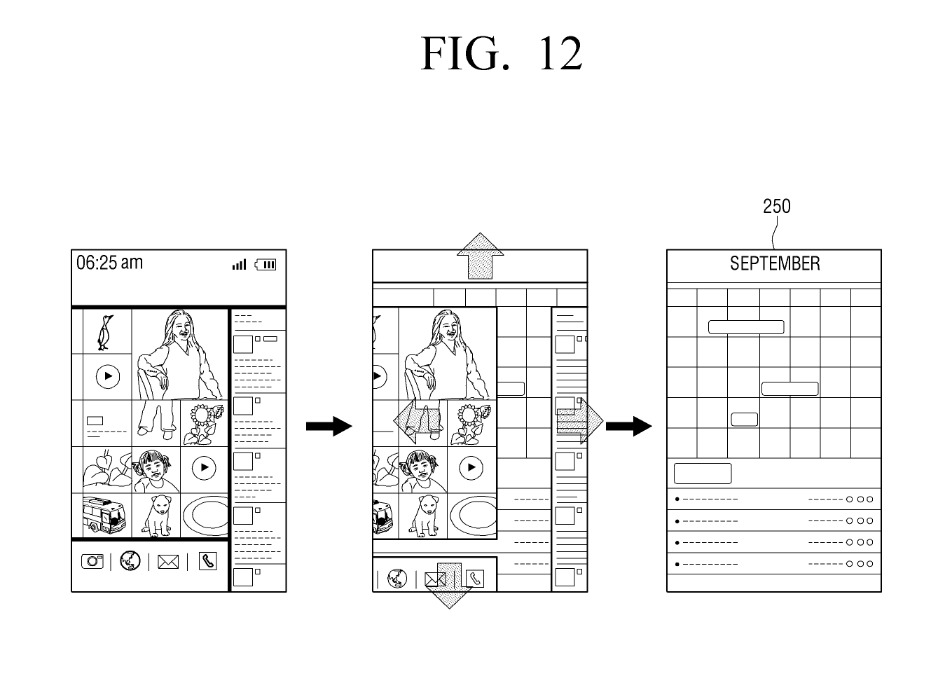

FIG. 12 illustrates a process of displaying the hidden area in response to the above-mentioned manipulation. Referring to FIG. 12, if the user inputs a first pre-defined manipulation on the background screen that is the combination of a plurality of areas, the areas are moved apart from each other, showing the hidden area 250. In such a state, if the user inputs a second pre-defined manipulation, the plurality of areas move close to each other and are combined to thus reconstruct the background screen. The second manipulation is made in an opposite direction to the first manipulation. That is, if the first manipulation is the touching with three fingers and separating the three points apart from each other, the second manipulation is touching with three fingers and moving the points of the fingers close to each other.

The hidden area may display various objects depending on the embodiment. In one embodiment, the hidden area is one application screen as designated by the user, most-recently executed application screen, and application list. FIG. 12 illustrates an example in which the user designates a calendar application, in which the execution screen of the calendar application appears as the hidden area 250.

FIGS. 6 to 12 illustrate various examples where the background screen is reconstructed in response to the user's touch and dragging. However, other examples are also possible. For example, the background screen could be reconstructed using a direction key provided on the main body of the display device 110, or using a voice recognition technique. Further, various constructions explained above could be implemented on screens other than the background screen.

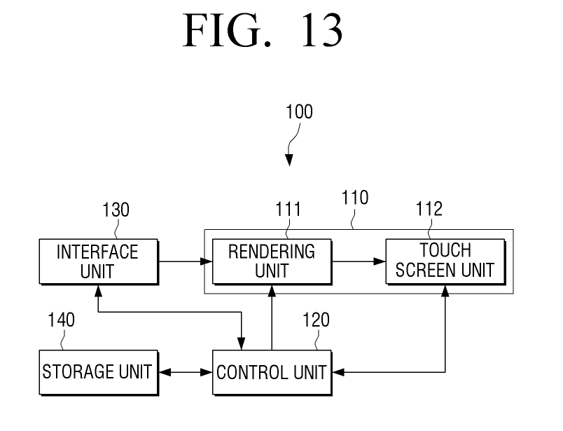

FIG. 13 is a block diagram of the display device 100 according to the present invention. Referring to FIG. 13, the display device 100 includes a display unit 110, a control unit 120, an interface unit 130 and a storage unit 140.

The display unit 110 may include a rendering unit 111 and a touch screen unit 112. The touch screen unit 112 displays various screens thereon, and senses whether the user touches on a corresponding screen and provides the result of sensing to the control unit 120. The touch screen unit 112 may include a display panel, a touch or pressure sensor, a backlight unit, or a driving circuit. Since the touch screen technique is well known and is not essential matter as to the embodiment of FIG. 13, a description and illustration thereof will be omitted for the sake of brevity.

The rendering unit 111 constructs the background screen and provides the touch screen unit 112 with the same. Specifically, the rendering unit 111 constructs various Graphic User Interface (GUI) objects with the various information including an execution screen corresponding to the respective applications or functions executed at the control unit 120, transmission and reception messages, texts, and performs rendering to display the objects on the areas designated according to type. The storage unit 140 may store various data such as Operating System (O/S), various applications, settings, and execution data.

The control unit 120 may control the display unit 110 to display the background screen divided into a plurality of areas, by executing the various programs stored at the storage unit 140.

According to the control of the control unit 120, the communication interface unit 130 may perform communication with various external sources, such as connecting a call via a communication net, or connecting to a network such as the Internet to download a Short Message Service (SMS) message, widget information and media content.

The control unit 120 may reload the objects corresponding to an expanded area, if the user expands one of the plurality of areas constructing the background screen when the background area is displayed. Specifically, the control unit 120 may read out the information stored at the storage unit 140, or access an external server via the communication interface unit 130 to receive information. The control unit 120 may control the display unit 110 to rearrange the objects using the reloaded information and display the resultant re-arranged background screen.

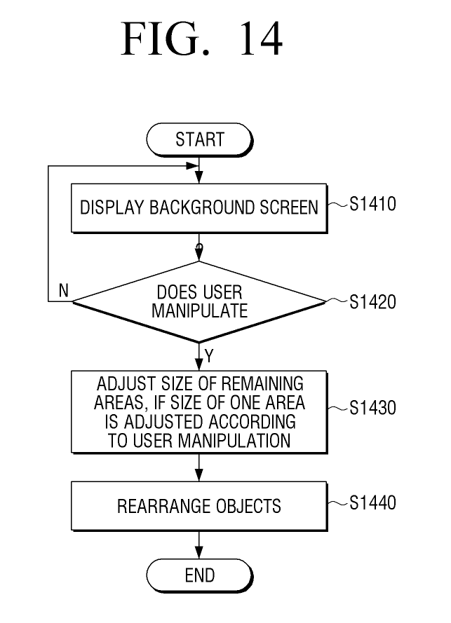

FIG. 14 illustrates a display method according to an embodiment of the present invention. Referring to FIG. 14, at S1410, a background screen divided into a plurality of areas is displayed. The background screen is constructed in various forms as explained above with reference to FIGS. 2 to 12.

The user may select an object on the background screen and play back the content directly, or may choose to change to a new screen. That is, if the media content is selected, the media content is played back directly on the background screen, with output of a video or audio signal. If photo is selected, the photo is displayed in expanded size within a corresponding area. If an icon representing an application is selected, the selected application is executed and the background screen is changed into the application execution screen, or the application executing screen is outputted only on the corresponding area.

If the user inputs a manipulation, at S1420 and S1430, the size of the area is changed according to the user's manipulation and the background screen is reconstructed. In this example, the respective areas are changed in relation to each other so as not to overlap each other. That is, if one area is expanded, the remaining areas are reduced.

At S1440, the objects are rearranged according to the changed sizes of the respective areas. Since the constitution of the background screen and the arrangement of the objects have been explained above with reference to various embodiments, a redundant explanation thereof will be omitted for the sake of brevity.

Further, although not illustrated in FIG. 14, various steps may additionally be provided depending on various embodiments of the display method.

That is, if an area is expanded, the step of automatically reloading the objects to be displayed on the expanded area from the source and displaying the same is additionally performed.

Further, if a pre-defined user manipulation is inputted, a step of moving the plurality of areas apart from each other, thereby showing the hidden area on the background screen, may additionally be performed.

Alternatively, if two points on one of the plurality of areas are touched and dragged apart from each other, a step of displaying detailed information on the area may additionally be performed.

Further, in each embodiment, the plurality of areas of the background screen may include a text display area to display text information, a content display area to display media content, an icon display area to display an icon representing a function provided by the display device 100, an application display area to display an icon of the application, a message display area to display a transmitted and received message, a preferred function display area to display an icon representing the preferred function, and a widget area to provide a widget service, or a combination thereof.

Further, the objects displayed on the background screen may include playable dynamic content.

The programs to perform methods according to various embodiments are recorded on various types of recording media and used.

Specifically, codes for executing the method are recorded on various types of terminal-readable recording media including, for example, RAM (Random Access Memory), flash memory, ROM (Read Only Memory), EPROM (Erasable Programmable ROM), EEPROM (Electronically Erasable and Programmable ROM), register, hard disk, removable disk, memory card, USB memory, or CD-ROM.

The foregoing embodiments and advantages are not to be construed as limiting the present invention. The present teachings can be readily applied to other types of apparatuses. Also, the description of embodiments of the present invention is intended to be illustrative, and not to limit the scope of the claims, and many alternatives, modifications, and variations will be apparent to those skilled in the art.

What is claimed is:

1. A display device, comprising:
a display unit which displays a screen divided into a plurality of areas on which different types of objects are displayed; and
a control unit which changes sizes of the respective areas of the screen in relation to each other and does not overlap the respective areas with each other, automatically reloads objects to be displayed on the changed areas from a source and reconstructs the screen, according to a user manipulation.

2. The display device of claim 1, wherein the control unit reloads objects displayed on an expanded area of the plurality of areas from the source, and rearranges the reloaded objects with existing objects according to a layout of the expanded area.

3. The display device of claim 1, wherein at least one of the plurality of areas is scrollable in response to the user manipulation.

4. The display device of claim 1, wherein the control unit expands or reduces at least one of the plurality of areas in accordance with the user manipulation which touches on a boundary between the plurality of areas and drags, and adjusts sizes of remaining areas of the screen according to a degree of expansion or reduction.

5. The display device of claim 1, wherein, in accordance with the user manipulation which touches on one of the plurality of areas and drags to a direction of a boundary with another area, the control unit expands a size of the touched area, while reducing a size of remaining areas of the screen.

6. The display device of claim 1, wherein, if two points in one area of the plurality of areas are touched and dragged apart from each other, the control unit displays detailed information on the one area.

7. The display device of claim 1, wherein, if the user manipulation is inputted and touches on a plurality of points and moves the touched points apart from each other, the control unit displays an area that is hidden at a lower portion of the plurality of areas, on the screen.

8. The display device of claim 7, wherein the hidden area displays one of an application screen designated by the user, a most-recently executed application screen, and an application list.

9. The display device of claim 1, wherein one of the plurality of areas displays an application list which displays a preferred function list and an entire application, objects displayed on the preferred function list and the application list are movable between the preferred function list and the application list depending on a choice of the user, and the application list is scrollable.

10. The display device of claim 1, wherein the plurality of areas comprises at least one of:
a text display area which displays text information, a content display area which displays media content, an icon display area which displays icons representing functions provided by the display device, an application display area which displays an application icon, a message display area which displays transmitted and received messages, a preferred function display area which displays an icon representing the preferred function, and a widget area which provides a widget service.

11. The display device of claim 1, wherein the objects displayed on at least one of the plurality of areas comprises dynamic content playable on the screen.

12. A display method, comprising:
displaying a screen divided into a plurality of areas on which different types of objects are displayed;
changing sizes of the respective areas of the screen in relation to each other and preventing the respective areas from overlapping each other, when a size of one of the plurality of areas is changed according to a user manipulation; and
automatically reloading objects to be displayed on the at least one area of the changed areas from a source and reconstructing the screen.

13. The display method of claim 12, wherein reconstructing the screen comprises reloading objects displayed on an expanded area of the plurality of areas from the source, and rearranging the reloaded objects with existing objects according to a layout of the expanded area.

14. The display method of claim 12, wherein at least one of the plurality of areas is scrollable in response to the user manipulation.

15. The display method of claim 12, wherein the sizes of the plurality of areas are changed in accordance with the user manipulation which touches on a boundary between the plurality of areas and drags, or which touches on one of the plurality of areas and drags to a direction of a boundary of another area.

16. The display method of claim 12, wherein, when the user manipulation is inputted and touches on a plurality of points and moves the touched points apart from each other, an area hidden at a lower portion of the plurality of areas is displayed on the screen.

17. The display method of claim 16, wherein the hidden area displays one of an application screen designated by the user, a most-recently executed application screen, and an application list.

18. The display method of claim 12, wherein, when two points on one of the plurality of areas are touched and dragged apart from each other, detailed information is displayed on the area.

19. The display method of claim 12, wherein the plurality of areas comprises at least one of:
a text display area which displays text information, a content display area which displays media content, an icon display area which displays icons representing functions provided by the display device, an application display area which displays an application icon, a message display area which displays transmitted and received messages, a preferred function display area which displays an icon representing the preferred function, and a widget area which provides a widget service.

20. The display method of claim 12, wherein the objects displayed on at least one of the plurality of areas comprises dynamic content playable on the screen.
